(19) United States
(12) Patent Application Publication
(10) Pub. No.: US 2005/0110363 A1
(43) Pub. Date: May 26, 2005

(54) Method for producing a spindle motor and a spindle motor for a hard disk drive

(76) Inventors: Jorg Hoffmann, Mettlach (DE); Andreas Kull, Donaueschingen (DE); Jurgen Oelsch, Hohenroth (DE); Olaf Winterhalter, Eppendorf (DE)

Correspondence Address: Mark C Comtois;Duane Morris, Suite 700, 1667 K Street N W, Washington, DC, 20006, US

(21) Appl. No.: 10/500,978

(22) PCT Filed: Jan. 9, 2003
(86) PCT No.: PCT/EP03/00155

(30) Foreign Application Priority Data
Jan. 9, 2002 (DE) 10200506.0

(51) Int. Cl. H02K 1/12; H02K 15/16; G11B 5/127

(52) U.S. Cl. 310/254; 29/596; 29/603.03; 720/695; 720/697

(57) ABSTRACT

In a method for the manufacture of a spindle motor for a hard disk drive comprising a stator, a rotor and a hydrodynamic bearing arrangement that rotatably supports the rotor, it is provided that the hydrodynamic bearing arrangement is prefabricated and fixedly connected to the rotor or the stator in a prefabricated state.

### FIELD OF THE INVENTION

The invention relates to a method for the manufacture of an electric motor, particularly a spindle motor for a hard disk drive, in accordance with the preamble in claim 1, and an electric motor, particularly a spindle motor for a hard disk drive, in accordance with the preamble in claim 10.

### BACKGROUND OF THE INVENTION

Spindle motors for PC assemblies, such as hard disk drives, in which a shaft that is fixedly connected to a rotor is journalled via a hydrodynamic bearing arrangement are known. A hydrodynamic bearing arrangement according to the prior art consists, for example, of a bearing sleeve which can be closed at one end by a counter plate. Within the bearing sleeve, a shaft is located which is surrounded by a fluid, preferably an oil. One or more groove patterns are provided on the inner surface of the bearing sleeve or on the outer surface of the shaft, these grooves being used to create hydrodynamic bearing pressure.

In order to manufacture a bearing arrangement according to the prior art, a bearing sleeve is first pressed into a stator flange. Due to deformation caused by press fitting, the bore in the bearing sleeve has then to be re-machined, particularly by being milled and/or ground, to ensure that the bearing surface of the bearing sleeve has the required dimensional accuracy, cylindricality and right angularity. Finally, one or more groove patterns are formed in the bearing surface to produce the hydrodynamic bearing pressure in the completed, fluid-filled bearing needed to journal the shaft in a stable and concentric manner.

As a rule, different materials are used for the bearing sleeve and the stator flange. During temperature changes, the two components can expand at different rates. Due to the press fit connection between the stator flange and the bearing sleeve, changes in expansion directly influence the size of the bearing gap required between the shaft and the bearing sleeve. Deviations from the ideal bearing gap size influence the bearing stiffness required for the vibration behavior and precise running of the system. Excessive deviation from the ideal bearing gap size can result in a total breakdown of the system.

Further, hard disk drives exist that have a non-rotationally symmetric baseplate which acts as a stator carrier. For purposes of production engineering, it is almost impossible to machine a bearing sleeve connected to such a baseplate.

It is the object of the invention to provide a method for the manufacture of a spindle motor for a hard disk drive by means of which a large variety of different types of spindle motors can be manufactured and mounted simply and at low-cost.

This object has been achieved by the features outlined in claim 1. Here, it is provided that the hydrodynamic bearing arrangement is prefabricated separately before it is fixedly connected to the relevant component—the stator or the rotor—of the spindle motor. This method enables large numbers of identically constructed hydrodynamic bearing arrangements to be prefabricated and employed in various motors. In addition, machining the bearing sleeve of the bearing arrangement to exact dimensions is made considerably easier for product engineering purposes as long as it is not mounted on a stator flange, baseplate or suchlike. A press fit, which causes the bearing sleeve to be deformed thus making it necessary to re-machine the bearing sleeve, is no longer required.

A particular advantage of the invention lies in the fact that the complete hydrodynamic bearing arrangement, including radial bearing and axial bearing, is prefabricated in such a way that it is fully functional before its final installation in the motor and can thus be tested.

It is advantageous if the prefabricated bearing arrangement is bonded with the relevant component of the spindle motor. The adhesive intended for this purpose is particularly suitable for data carriers if it has low gas emission properties. A transition fit can be provided between the bearing arrangement and the relevant component of the spindle motor. This enables exact parallelism between the rotational axis of the rotor and the alignment of the bearing sleeve to be achieved since the transition fit combined with the appropriate adhesive allows such a degree of freedom of assembly to be realized that the bearing sleeve can be precisely aligned with respect to the rotor or stator even after installation. When high-precision assembly tools are used, the prefabricated bearing arrangement can be inserted into the assembly flange or the baseplate with tolerances tending towards zero.

It is advantageous if the bearing arrangement is only connected to the relevant component of the spindle motor when the shaft has been set into the hydrodynamic bearing arrangement and the bearing oil has been inserted between the shaft and the bearing sleeve. This makes it possible to test the functionality of the prefabricated assembly of the hydrodynamic bearing arrangement before final mounting.

In a preferred embodiment, first a hub of the rotor is fixedly connected to the shaft which is accommodated in a bearing sleeve of the hydrodynamic bearing arrangement. The structural unit consisting of rotor hub, shaft and bearing arrangement is then mounted onto the stator. With this method of manufacture, a fabrication process is revealed that provides a high degree of flexibility in the assembly of a spindle motor having appropriate hydrodynamic bearings.

Further, it is the object of the invention to create a spindle motor for a hard disk drive whose functionality is in no way inferior to that of known spindle motors but which can be more easily realized in terms of product engineering. This object has been achieved by the characteristics outlined in claim 10.

The electric motor presented in the invention allows economic production in large numbers since it avoids having to work the bearing surfaces when the bearing arrangement is in a mounted state. Particularly for spindle motors whose stator is to be fixed on a non-rotationally symmetric baseplate, re-machining the bearing surfaces of the press fitted bearing sleeve is very complex in terms of product engineering. By bonding the bearing sleeve in a precisely engineered bore in the baseplate, a transition fit being provided in particular, the dimensions of the bearing sleeve are not changed during assembly, which means re-machining is no longer required

Other advantages, features and characteristics of the invention can be derived from the following description of a preferred embodiment of a spindle motor manufactured according to the invention on the basis of the attached drawings. The figures show:

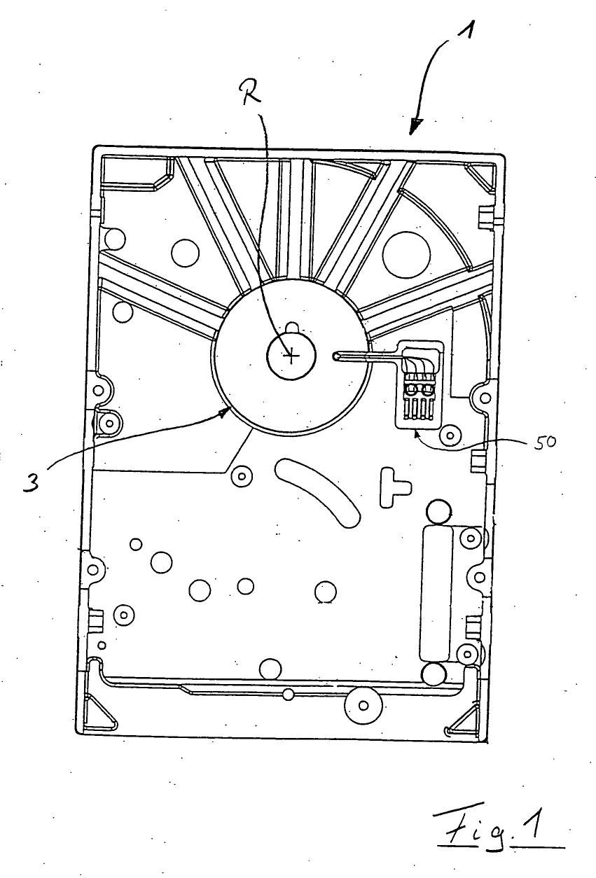

FIG. 1 a bottom view of a baseplate of a hard disk drive having a spindle motor according to the invention;

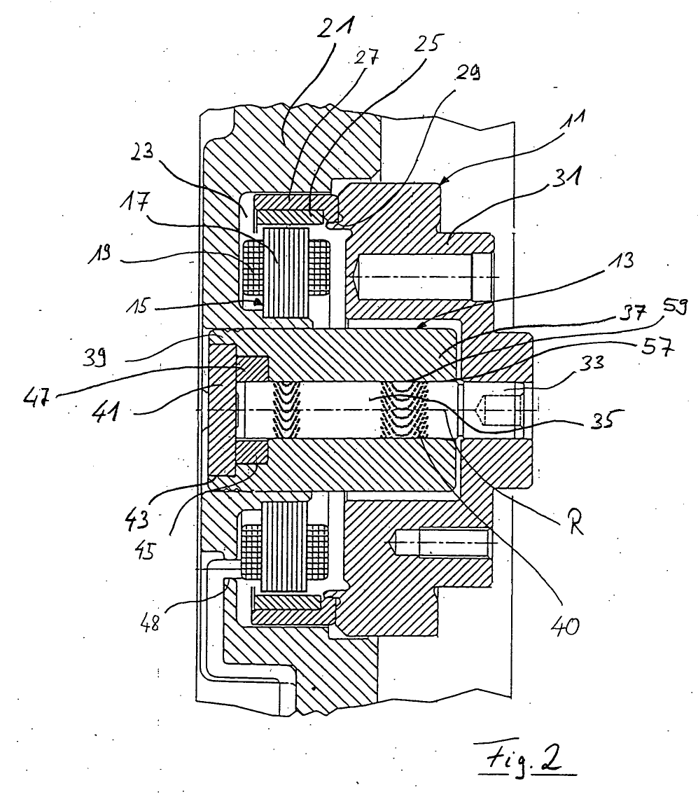

FIG. 2 a cross-sectional view of the spindle motor according to the invention;

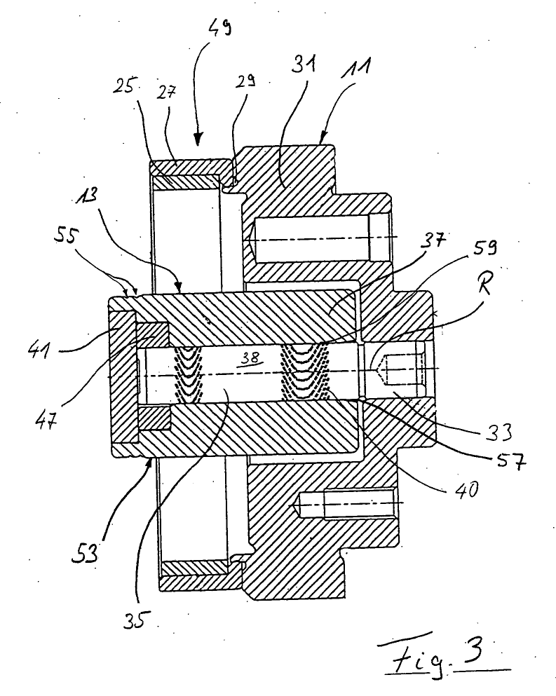

FIG. 3 a cross-sectional view of a unit comprising the bearing arrangement and the rotor;

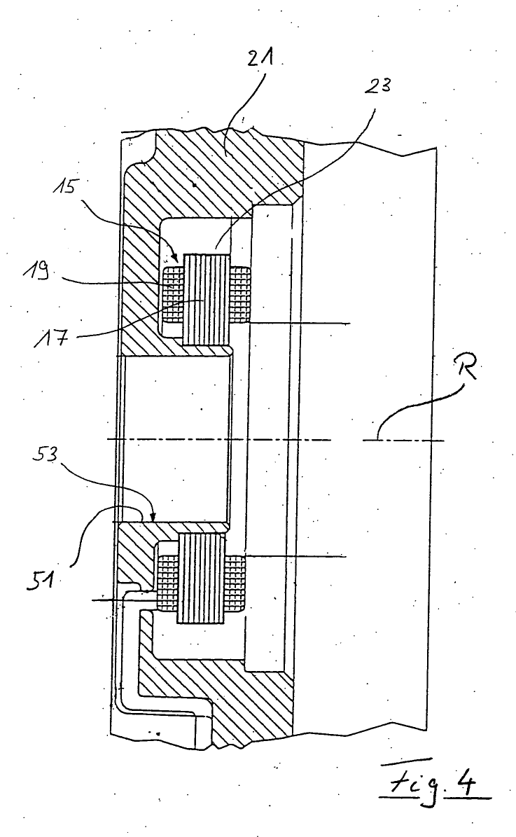

FIG. 4 a cross-sectional view of the stator; and

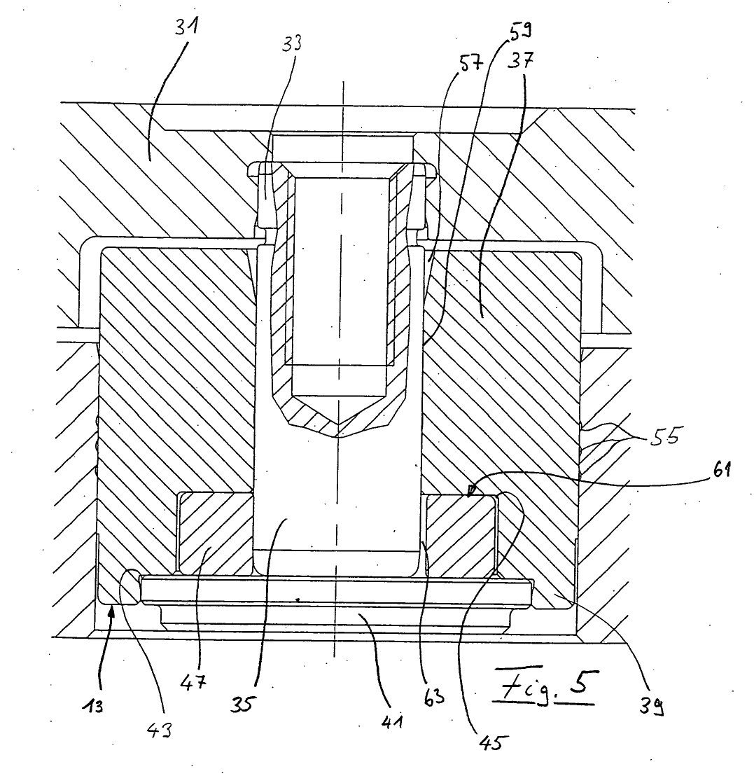

FIG. 5 a detailed view of the bearing arrangement of the spindle motor presented in the invention in accordance with FIG. 2.

A spindle motor 3 is essentially arranged in the middle of the inner side of the hard disk drive 1 facing away from the view shown in FIG. 1, whose rotational axis is indicated here by R. At least one hard disk platter is attached to the rotor of the spindle motor 3, the rotor not being illustrated in FIG. 1. This hard disk platter is set in rotation by the spindle motor 3, the read/write heads that are guided at a short distance above the surface of the disk being able to store and reread relevant data on the hard disk platter.

FIG. 2 shows the spindle motor 3 according to the invention, the rotor 11 with the bearing arrangement 13 or the stator 15 being shown in FIG. 3 or 4 respectively, before assembly.

The stator 15 has a stator core 17 that is wound with stator coils. The stator core 17 is fixed to a baseplate 21 by means of an adhesive. The stator 15 is accommodated in an annular recess 23 in the baseplate 21.

The stator 15 is encompassed by an annular rotor drive magnet 25 and separated from this by a concentric air gap. The rotor drive magnet 25 is held in a magnet receiving ring 27 formed as a back iron yoke, the magnet receiving ring 27 being pressed into a shoulder ring 29 incorporated into the rotor hub 31. The rotor hub 31 is pressed onto the drive end 33 of a shaft 35. The shaft 35 extends through a bearing sleeve 37 of the hydrodynamic bearing arrangement 13 which allows the shaft 35 to rotate around the rotational axis R. The bearing sleeve 37 has an inner bearing surface 38 having a groove pattern 40 to distribute the bearing oil evenly and to build up the necessary bearing fluid pressure in the hydrodynamic bearing arrangement 13.

The bearing sleeve 37 is sealed at one end 39 by a counter disk 41 (see also FIG. 5) which is pressed into one inner shoulder 43 of the bearing sleeve 37. An axial ring is fitted into another shoulder 45 that is stepped radially inwards. The counter disk 41 and the axial ring 47 can additionally be bonded.

A hydrodynamic radial thrust bearing is formed by the groove pattern 40 on the inner bearing surface 38 of the bearing sleeve 37 which stabilizes the shaft 35 in a radial direction when in operation. For this purpose, one or more axially spaced groove patterns can be provided on the inner bearing surface 38. Instead of being formed on the inner bearing surface 38, the groove patterns can also be formed on the outer diameter of the shaft 35. The groove patterns can take the form, for example, of spirals, sinus curves and/or a herringbone pattern.

In the bearing according to the invention, a hydrodynamic axial thrust bearing is furthermore formed between the counter disk or counter plate 41 and the axial ring or thrust ring 42. For this purpose, groove patterns can likewise be formed on one of the surfaces facing each other of the counter disk 41 and the axial ring 47 or on the end of the shaft, these grooves being used to build up the bearing fluid pressure required for the hydrodynamic bearing.

The groove pattern enables bearing pressure to be built up in both a radial and an axial direction and prevents material contact between the components of the hydrodynamic bearing that rotate with respect to each other during operation. Depending on the application, one or two radial bearings are formed along the length of the shaft by means of a groove pattern on the outer diameter of the shaft and/or on the inner surface of the bearing tube.

An annular, conical tapered area 57 can be formed between the shaft 35 and the inner surface of the bearing sleeve 37 which is connected via a capillary annular gap to the air gap 59 between the shaft 35 and the bearing sleeve 37 and forms a capillary seal for the bearing gap. The basic principles of such “capillary seals” are described, for example, in U.S. Pat. No. 5,667,309. The tapered area 57 forms an expansion volume and reservoir that is connected to the bearing gap 59 into which the bearing fluid can rise when the fluid level increases as the temperature rises. This goes to prevent the bearing fluid from leaking out of the bearing gap 59.

The annular tapered area 57 can be formed by a chamfer on the inner surface of the central aperture of the bearing sleeve 37 or through the shaft 35 being tapered.

A hole 48 is provided in the baseplate 21 through which the stator 15 is connected to a power supply 50 via insulated leads.

FIGS. 3 and 4 clearly demonstrate the order of assembly for the manufacture of the spindle motor 3. It is only after the assembly 49 (FIG. 3) consisting of the bearing arrangement 13, the shaft 35 and the rotor 11 has been prefabricated that it is placed and fastened in a bore 51 formed in the baseplate 21. The bore 51 and the contact surface 53 of the bearing sleeve 37 are formed as a transition fit. To ensure that the bearing sleeve 37 and the bore 51 are fixedly connected, an adhesive is provided which is applied to the respective contact surfaces 53 before assembly. To ensure that the bonding between the bearing sleeve 37 and the bore 51 has the required stiffness, sufficient volume for the bonding agent must be available and the bonded surfaces have to be covered as fully as possible with adhesive. However, the volume for the adhesive should be kept as small as possible to ensure that the required assembly precision is maintained. To provide the necessary volume for the adhesive, notches or grooves are provided on the contact surface 53 into which the adhesive penetrates when the bearing sleeve 37 is inserted, thus ensuring that the bonded connection has the necessary stiffness.

The adhesive bonding between the bearing sleeve 37 and the baseplate 2, enables the bearing sleeve 37 to be precisely adjusted with respect to the rotational axis R of the shaft 33, the bore 51 and the rotor drive magnet 25.

A preferred method of manufacture of the spindle motor 3 is given in detail below:
1. Fixing the stator 15 into the annular recess 23 of the baseplate 21;
2. Manufacture of the bearing sleeve 37 with precise bearing dimensions
3. Formation of the groove pattern 40 on the inner bearing surface 38 of the bearing sleeve 37;
4. Fixing the axial ring 41 to one end of the shaft 35, particularly using an interference fit;
5. Inserting the shaft into the bearing sleeve;
6. Sealing one end of the bearing sleeve 37 with the counter disk 41;
7. Inserting the fluid in the bearing gap between the shaft 35 and the inner bearing surface 38 of the bearing sleeve 37;
8. Preparing the rotor 11 including the rotor drive magnet 25 and the magnet receiving ring 27;
9. Establishing the shaft hub connection between the rotor hub 31 and the shaft 35;
10. Testing the assembly 49 comprising the rotor 11, the shaft 35 and the bearing arrangement 13 for its functionality;
11. Application of an adhesive to the contact surfaces 53 of the bearing sleeve and the baseplate;
12. Insertion of the assembly 49 into the bore 51 provided in the baseplate 21.

The detailed view of the hydrodynamic bearing arrangement according to the invention shown in FIG. 5 once again clearly illustrates the prefabricated, complete hydrodynamic bearing arrangement 13 comprising the shaft 35, the bearing sleeve 37, the counter disk 41 and the axial ring 47. As mentioned above, a groove pattern is provided on the inner bearing surface 38 with the purpose of forming a radial hydrodynamic thrust bearing. Moreover, a groove pattern is formed on one of the surfaces facing each other of the counter disk 41 and the axial ring 47 or of the end face of the shaft 35 to form a radial hydrodynamic thrust bearing. Another groove pattern can be formed on one of the surfaces of the axial ring 47 and the bearing sleeve 37 that face each other, at 61 in the figure. This goes to form a hydrodynamic axial bearing that can take up loads in both axial directions of the shaft 35.

Further, in FIG. 5 a bore 63 in the axial ring 47 is shown which facilitates the circulation of bearing fluid between the bearing gap 59 and the bottom of the shaft 35.

FIG. 5 and FIG. 3 clearly demonstrate in particular that the hydrodynamic bearing arrangement according to the invention represents a complete, self-contained hydrodynamic bearing that includes both a hydrodynamic radial bearing as well as a hydrodynamic axial bearing. This hydrodynamic bearing is fully functional even in the pre-assembled state shown in FIG. 3 and can be tested for its functionality in this pre-assembled state. This has the considerable advantage that the bearing need not be first installed in a motor before it can be tested. Thus, in the event of a bearing defect, additional assembly cost and effort as well as additional unnecessary rejects can be avoided.

The characteristics revealed in the above description, the figures and the claims can be important for the realization of the invention both individually and in any combination whatsoever.

Identification Reference List

1. Hard disk drive
3. Spindle motor
11. Rotor
13. Bearing arrangement
15. Stator
17. Stator core
19. Stator coil
21. Baseplate
23. Annular recess
25. Rotor drive magnet
27. Magnet receiving ring
29. Shoulder ring
31. Rotor hub
33. Drive end
35. Shaft
37. Bearing sleeve
38. Inner bearing surface
39. End of 37
40. Groove pattern
41. Counter disk
43. Inner shoulder
45. Stepped inner shoulder
47. Axial ring
48. Hole
49. Unit
50. Power supply
51. Bore
53. Contact surface
55. Groove
57. Tapered area
59. Bearing gap
61. Surface with groove pattern
63. Bore
R Rotational axis

1. A method for the manufacture of an electric motor for a hard disk drive comprising a stator (15), a rotor (11), a shaft (35) and a hydrodynamic bearing arrangement (13) which rotatably supports the rotor (11) with respect to the stator (15), wherein
a) a bearing sleeve (37) of the hydrodynamic bearing arrangement (13) is manufactured;
b) an axial ring (47) is fixed to one end of the shaft (35);
c) the shaft (35) is inserted together with the axial ring (47) into bearing sleeve (37);
d) one end of the bearing sleeve (37) is sealed with a counter disk (41);
e) bearing fluid is inserted into a bearing gap between the shaft (35) and the bearing sleeve (37); and
f) the assembly (49) consisting of the shaft (35) and the bearing arrangement (13) is tested before it is installed in the spindle motor.

2. A method according to claim 1, wherein the shaft (35) is connected to a rotating component (11) of the spindle motor before the assembly is tested.

3. A method according to claim 2, wherein the rotating component is the rotor (11) of the spindle motor.

4. A method according to claim 1 wherein the prefabricated bearing arrangement (13) is bonded to the rotating component.

5. A method according to claim 4, wherein an adhesive with low gas emission properties is used.

6. A method according to claim 1 wherein during manufacture of the bearing sleeve (37), the inner bearing surface (38) of the bearing sleeve (37) is provided with a groove pattern (40).

7. A method according to claim 1 wherein a transition fit is provided at a fixed assembly section between the bearing arrangement (13) and the stator (15) or the rotor (11).

8. A method according to claim 1 wherein the bearing sleeve (37) is fixedly mounted onto the stator (15).

9. A method according to claim 1 wherein a hub (31) of the rotor (11) is fixedly connected to the shaft (35), with a unit consisting of rotor hub (31), shaft (35) and bearing sleeve (37) then being mounted with respect to the stator (15).

10. A spindle motor for a hard disk drive comprising a rotor (11), a stator (15), a shaft (35) and a hydrodynamic bearing arrangement (13) that rotatably supports the rotor (11) with respect to the stator (15), the hydrodynamic bearing arrangement having a bearing sleeve (37) on whose inner surface (38) a groove pattern (40) is formed in order to create a hydrodynamic radial bearing, an axial ring (47) being mounted onto the shaft (35) to create a hydrodynamic axial bearing, the shaft (35) being inserted into the bearing sleeve (37), one end of the bearing sleeve (37) being sealed with a counter disk (41), bearing fluid being inserted into the bearing gap between the shaft (35) and the bearing sleeve (37), and the hydrodynamic bearing arrangement (13) thus produced forming a fully functional unit that can be tested before being mounted onto the rotor (11) or the stator (15) of the spindle motor

11. A spindle motor according to claim 10, wherein the stator (15) or the rotor (11) is firmly fixed to the outer surface of the bearing sleeve (37).

12. A spindle motor according to claim 10 wherein the shaft (35) is inserted into the bearing sleeve (37) before the bearing arrangement is mounted onto the stator (15) or the rotor (11).

13. A spindle motor according to claim 10 wherein a transition fit is provided between the bearing arrangement (13) and the stator (15) or the rotor (11).

14. A spindle motor according to claim 10 wherein the hydrodynamic bearing arrangement 13 is fixedly connected to the rotor (11) or the stator (15).

15. A spindle motor according to claim 14, wherein a groove (55) is provided on at least one of the bonded contact surfaces of either the bearing arrangement (13) or the stator (15) or the rotor (11).

16. A hard disk drive having a spindle motor according to claim 10.

17. A hydrodynamic bearing arrangement for an electric motor comprising a stator (15), a rotor (11), a shaft (35) and the hydrodynamic bearing arrangement (13), which rotatably supports the rotor with respect to the stator, the hydrodynamic bearing arrangement (13) having a bearing sleeve (37), an axial ring (47) being mounted onto one end of the shaft (35) and the shaft (35) being inserted into the bearing sleeve (37); the corresponding end of the bearing sleeve (37) being sealed with a counter disk (41; bearing fluid being inserted into the bearing gap between the shaft (35) and the bearing sleeve (37), and the unit thus formed from the hydrodynamic bearing arrangement (13) and the shaft (35) forming a fully functional unit that can be tested and mounted onto the stator (15) or the rotor (11).
